(19) United States
(12) Patent Application Publication
(10) Pub. No.: US 2008/0002601 A1
(43) Pub. Date: Jan. 3, 2008

(54) METHOD AND APPARATUS FOR RELAYING SPATIALLY-MULTIPLEXED SIGNALS

(76) Inventors: Pedro E. Coronel, Thalwil (CH); Wolfgang H. Schott, Rueschlikon (CH)

Correspondence Address: IBM CORPORATION, T.J. WATSON RESEARCH CENTER, P.O. BOX 218, YORKTOWN HEIGHTS, NY, 10598, US

(21) Appl. No.: 11/427,833

(22) Filed: Jun. 30, 2006

(51) Int. Cl. H04J 3/08

(52) U.S. Cl. 370/315

(57) ABSTRACT

The present invention discloses a MIMO relay apparatus comprising a data source node, a relay node, and a destination node. The data source node sends a source send data x over a first radio channel H. The relay node receives a relay receive data yᵣ from said first radio channel H, applying a relay transformation Φ to relay receive data yᵣ to obtain a relay send data xᵣ. The relay node further sends relay send data xᵣ over a second radio channel G. The destination node receives a destination receive data y from second radio channel G, and applies a destination transformation Ψ to destination receive data y to obtain a destination output data r representing an estimate of said source send data x. Relay transformation Φ and said destination transformation Ψ are jointly tuned with respect to each other.

### FIELD OF THE INVENTION

The present invention relates to wireless signal relaying technologies. More specifically, the present invention relates to a scheme for relaying spatially multiplexed signals.

### BACKGROUND

Multiple-Input Multiple-Output (MIMO) wireless systems have the ability to achieve better error performance than traditional single-antenna systems as they exploit antenna diversity. Moreover, MIMO wireless systems can support higher data rates by opening parallel data pipes for transmission through the wireless channel. These advantages have converted MIMO technology in to a key element for the evolution of current wireless standards. For instance, MIMO technology has been adopted in the 11n amendment of the IEEE 802 Wireless Local Area Network (WLAN) standard. It is also employed in the IEEE 802.16 Broadband Wireless Metropolitan Area Network (WMAN) standard. Multiple-antenna techniques are under consideration in the Third Generation Partnership Project 2 (3GPP2) community, which is developing an evolution for 3^{rd} generation (3G) systems. These techniques are also used in research projects that aim to set the basis for the 4^{th} generation (4G) of wireless communication systems.

On the other hand, the relaying of signals in wireless networks is an increasingly popular technology in which an intermediate node, a relay, processes the signal received from a data source node before forwarding it to a destination node. Relays are able to compensate for the power attenuation and the fading due to signal propagation, increasing thereby the range and reliability of communications. This technique is of particular interest for ad-hoc networks where no fixed infrastructure exists, and it helps to increase the cell range in cellular networks. Relaying is a potentially important feature of systems beyond 3G and 4G. For example, the recent IEEE 802.16a WMAN specification already includes this technology.

Multiple conventional relaying techniques trade implementation complexity for error performance. In one known relaying technique, Decode-and-Forward (DF), the relay decodes and detects the stream transmitted by the source. Thereafter, the stream is re-encoded before forwarding it to the destination. Since a DF relay implements the full receiver chain, it incurs high computational complexity and achieves good error performance. At the other extreme another known relaying technique, Amplify-and-Forward (AF), only amplifies the signal strength. This operation is simpler to implement but performs poorly with respect to DF.

Future generation wireless systems have to fulfill stringent requirements in data rates and reliability. These requirements call for simultaneously exploiting MIMO and relaying gains. However, the integration of multi-antenna techniques at feasible complexities is a challenging task.

A variety of approaches have been employed to improve the error performance of MIMO relaying. A known approach to reduce the error rate in MIMO wireless channels is transmitter and receiver filter tuning. In another known approach, the relay removes the interstream interference resulting from the propagation of a space-time signal. In yet another known approach, multiple relays are considered to forward a packet from a source to a destination. Yet another known approach computes the optimal waveform design for MIMO relaying.

However, all the aforementioned approaches suffer from one or more of the following drawbacks. First, the approach does not consider coordinated relay and destination processing to improve error performance. Second, the approach has high computational complexity. Thus, there is a need for a computationally simple joint tuning scheme for relaying spatially multiplexed signals, for example in MIMO wireless systems. Further, there is a need for a relaying scheme that performs better than conventional simple schemes such as Amplify-and-Forward (AF).

### SUMMARY

The present invention discloses a MIMO relay apparatus comprising a data source node, a relay node, and a destination node. The data source node sends a source send data x over a first radio channel H. The relay node receives a relay receive data yᵣ from said first radio channel H, applying a relay transformation Φ to relay receive data yᵣ to obtain a relay send data xᵣ. The relay node further sends relay send data xᵣ over a second radio channel G. The destination node receives a destination receive data y from second radio channel G, and applies a destination transformation Ψ to destination receive data y to obtain a destination output data r representing an estimate of said source send data x. Relay transformation Φ and said destination transformation Ψ are jointly tuned with respect to each other.

In an embodiment, the joint tuning of relay transformation Φ and destination transformation Ψ reduces a mean square error (MSE) between source send data x and destination output data r.

In another embodiment, relay transformation Φ and destination transformation Ψ are chosen so that destination output data r is the maximum-likelihood estimate of the source send data x.

The present invention further discloses an apparatus for relaying data, an apparatus for receiving data, a MIMO wireless network node and an operating method thereof.

### BRIEF DESCRIPTION OF DRAWINGS

FIG. 1 depicts a MIMO relay apparatus in accordance with an embodiment of the present invention.

FIG. 2 is a flowchart depicting a method of selecting the relay and destination transformations in accordance with an embodiment of the present invention.

FIG. 3 is a flowchart depicting an iterative method of computing the Lagrange multiplier μ for a permutation of the singular values of the channel matrices H and G.

FIG. 4 is a block diagram schematically depicting a MIMO wireless network node, in accordance with an embodiment of the present invention.

FIG. 5 shows a schematic diagram of a MIMO wireless network node in accordance with another embodiment of the present invention.

### DETAILED DESCRIPTION

The present invention is directed to relaying of wireless signals in MIMO wireless networks where the signals are transmitted and received by nodes using multiple antennas that are spatially separated from one another. More specifically, various embodiments of the present invention address relaying of signals between a data source node and a destination node within a wireless network using a relay node having multiple-antennas. The inventive technique reduces communication errors using jointly tuned linear signal processing in the relay and destination nodes.

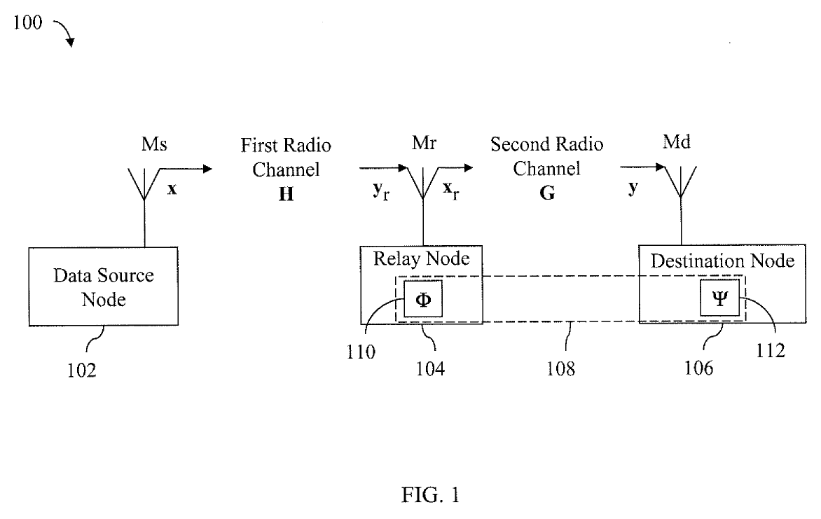

FIG. 1 depicts a block diagram of a portion of a MIMO relay apparatus 100 in accordance with an embodiment of the present invention. The MIMO relay apparatus 100 comprises a data source node 102 equipped with Ms antennas, a relay node 104 equipped with Mr antennas, and a destination node 106 equipped with Md antennas, where Ms, Mr, and Md are integers. A data processing system 108, comprising a relay data processor 110 and a destination data processor 112 is distributed between the relay node 104 and the destination node 106. More specifically, relay data processor 110 is coupled with relay node 104, and destination data processor 112 is coupled with destination node 106. The number of antennas used at the source, relay and destination nodes is only constrained by the relation Ms≦min(Md,Mr). Various embodiments of the present invention apply to configurations that employ any arbitrary number of antennas that satisfy the aforementioned relation. Typically, MIMO systems employ between 2 and 4 antennas at each node.

Data source node 102 can multiplex a maximum of Ms streams using Ms antennas. Data source node 102 communicates data to destination node 106 via relay node 104. In order to do this, data source node 102 transmits a source send data x onto a first radio channel H. Here, x is a vector of length Ms and represents source send data transmitted by data source node 102 using Ms antennas. The elements of source send data x are information symbols [x₁, x₂, . . . , x_{Ms}]. Further, H is a matrix of dimensions (Mr, Ms) and represents the transformation that the first radio channel performs on a signal transmitted by the antennas at data source node 102, as observed from the antennas at relay node 104. Source send data x is observed at relay node 104 as relay receive data yᵣ. Here, yᵣ is a vector of size Mr and represents relay receive data received by relay node 104 using Mr antennas. Further, relay data processor 110 processes relay receive data yᵣ using a relay transformation Φ to obtain relay send data xᵣ. Relay transformation Φ can be mathematically represented as a matrix of dimensions (Mr, Mr).

Similarly, relay send data xᵣ is retransmitted by relay node 104 over second radio channel G to destination node 106. Here xᵣ is a vector of length Mr and represents relay send data transmitted by relay node 104 using Mr antennas. Further, G is a matrix of dimensions (Md, Mr) and represents the transformation that the second radio channel performs to a signal transmitted by the antennas at relay node 104, as observed from the antennas at destination node 106. Relay send data xᵣ is observed at destination node 106 as destination receive data y. Here, y is a vector of size Md and represents relay receive data received by destination node 106 using Md antennas. Destination data processor 112 processes destination receive data y using a destination-unit transformation Ψ to get destination output data r. Destination-unit transformation Ψ can be mathematically represented as a matrix of dimensions (Ms, Md).

The present invention is directed at selecting jointly tuned linear transformations Φ and Ψ. Linear transformations Φ and Ψ are selected in a way that the mean square error (MSE) between x and r is reduced. In an embodiment, transformations Φ and Ψ are selected in a way that the mean square error (MSE) between x and r is minimized. The methods disclosed in conjunction with various embodiments of the present invention rely on the fact that both relay node 104 and destination node 106 have access to the current channel realization. In other words, relay node 104 and destination node 106 require information about the current state of a dynamic channel transform, or the current Channel State Information (CSI). Therefore, they need to update their CSI as dictated by the channel variation rate.

The mathematical basis for the present invention is briefly illustrated hereinafter. The apparatus and method disclosed in accordance with various embodiments of the present invention are applicable to spatial multiplexing in MIMO wireless networks with any combination of Ms, Mr, and Md satisfying Ms≦min(Md, Mr). While the transmission strategy disclosed hereinafter assumes that no direct communication path exists between data source node 102 and destination node 106, it would be apparent to one skilled in the art that the method and apparatus according to the present invention find application in MIMO wireless network where this simplification is not perfectly true. The simplification must not be construed as a limitation to the spirit and scope of the present invention.

The relation between x and yᵣ can be mathematically modeled as follows:

$${y}_{r} = \sqrt{\frac{{E}_{1}}{Ms}} Hx + \sqrt{{N}_{0}^{( 1 )}} {n}_{1} \qquad ( 1 )$$

where E₁ is signal energy and includes the path-loss, N₀⁽¹⁾ denotes the noise power at R, and n₁ is a first noise vector. First noise vector n₁ is assumed to be multivariate Gaussian according to CN(0,I_{Mr}), i.e. its entries are unit-variance zero-mean complex Gaussian random variables and mutually independent of each other.

Further, relay data processor 110 applies a relay transformation Φ to relay receive data yᵣ to obtain a relay transmit data xᵣ. This processing is denoted mathematically as follows:

xᵣ=\sqrt{s}Φyᵣ (2)

where s is an energy amplification factor, and relay transformation Φ does not alter the total signal power. In order to not alter the total signal power, relay transformation Φ must satisfy the condition: Tr (ΦΦ^{H})=Mr, where Tr(.) denotes the trace of a matrix, and Φ^{H} is the Hermitian transpose of Φ. Energy scaling factor s is used to remove the path-loss introduced by the first radio channel, and its value can be derived using the following condition:

sTr(yᵣ,yᵣ^{H})=Mr (3)

In an embodiment of the invention, the condition of equation (3) can be met on a channel realization basis, or it can be met in average. Without loss of generality, the inventor's mathematical model assumes that this is met in average. This leads to the relation:

$$s ( \frac{{E}_{1}}{Ms} ɛ \{ Tr ( {HH}^{H} ) \} + {N}_{0}^{( 1 )} Mr ) = Mr \qquad ( 4 )$$

Here, the value of ε{Tr(HH^{H})} depends on the channel distribution. For the purpose of illustration, and not to limit the scope and applicability of the teachings of the present invention, it is assumed that the elements of first radio channel H are independent and identically distributed according to CN(0,1). Therefore, ε{Tr(HH^{H})}=Ms.Mr. Energy amplification factor s can thus be expressed as:

$$s = \frac{1}{{E}_{1} + {N}_{0}^{( 1 )}} \qquad ( 5 )$$

Similarly, destination receive signal y is given by:

$$y = \sqrt{\frac{{E}_{2}}{Mr}} {Gx}_{r} + \sqrt{{N}_{0}^{( 2 )}} {n}_{2} \qquad ( 6 )$$

where the signal energy term E₂ includes the path-loss over the second radio channel, and N₀⁽²⁾ denotes the noise power at destination node 106. Second noise vector n₂ is assumed to be multivariate Gaussian according to CN(0,I_{Md}), i.e. its entries are unit-variance zero-mean complex Gaussian random variables and mutually independent of each other. Taking into account the linear transformation and the power scaling, the end-to-end signal model can be written as:

$$\begin{matrix}y = \sqrt{\frac{{E}_{1} {E}_{2}}{Ms . Mr}} \sqrt{\frac{1}{{E}_{1} + {N}_{0}^{( 1 )}}} G Φ . Hx + \\ \sqrt{\frac{{E}_{2}}{Mr}} \sqrt{\frac{1}{{E}_{1} + {N}_{0}^{( 1 )}}} \sqrt{{N}_{0}^{( 1 )}} G Φ . {n}_{1} + \sqrt{{N}_{0}^{( 2 )}} {n}_{2} \\ y = \sqrt{γ} G Φ . Hx + n\end{matrix} \qquad ( 7 )$$

where

$$γ = \frac{{E}_{1} {E}_{2}}{Ms . Mr} \frac{1}{{E}_{1} + {N}_{0}^{( 1 )}} .$$

Further, since the noises nᵢ˜CN(0,I), i ε{1, 2}, the equivalent noise term n is distributed according to CN (0,Rₙ), where Rₙ is the noise covariance matrix, and is given as:

$${R}_{n} = α G Φ {Φ}^{H} {G}^{H} + β {I}_{Md} \\ where α = \frac{{E}_{2} {N}_{0}^{( 1 )}}{Mr} \frac{1}{{E}_{1} + {N}_{0}^{( 1 )}} and β = {N}_{0}^{( 2 )} . \qquad ( 8 )$$

Further, the destination output data r is obtained from destination receive signal y by applying destination-unit transformation Ψ. This can be mathematically represented by the relation r=Ψy. Substituting equation (7) in this relation gives:

·r=\sqrt{γ}Ψ·G·Φ·x+Ψ·n (9)

where n is additive white Gaussian noise distributed according to CN (0,Rₙ).

The vector r is an estimate of the transmitted vector x. The tuning of Φ and Ψ is to reduce the mean square error (MSE) between r and x. This tuning problem can be stated as:

$${min}_{Φ , Ψ : Tr ( Φ {Φ}^{H} ) \leq Mr} ɛ \{ {‖ x - r ‖}_{F}^{2} \} = {min}_{Φ , Ψ : Tr ( Φ {Φ}^{H} ) \leq Mr} Tr ( {C}_{e} ) \qquad ( 10 )$$

where the expectation ε is taken over the statistics of source send data x, and the error covariance matrix can be computed as follows:

Cₑ=(\sqrt{γ}ΨGΦH−I)(\sqrt{γ}ΨGΦH−I)^{H}+αΨGΦΦ^{H}G^{H}Ψ^{H}+βΨΨ^{H} (11)

This tuning problem can be solved by using Lagrange's method and Karush-Kuhn-Tucker (KKT) conditions. Denoting the Lagrange multiplier by μ, the Lagrangian is written as:

L(μ,Φ,Ψ)=Tr(Cₑ)+μ(Tr(ΦΦ^{H})−Mr) (12)

Thereafter, the KKT conditions are applied to pair (Φ,Ψ) as follows:

$$\begin{matrix}\frac{\partial }{\partial Φ} L ( μ , Φ , Ψ ) = 0 & ( 13 ) \\ \frac{\partial }{\partial Ψ} L ( μ , Φ , Ψ ) = 0 & ( 14 ) \\ μ ( Tr ( Φ {Φ}^{H} ) - Mr ) = 0 & ( 15 ) \\ ( Tr ( Φ {Φ}^{H} ) - Mr ) \leq 0 & ( 16 ) \\ μ \geq 0 & ( 17 )\end{matrix}$$

Considering a matrix and its Hermitian transpose as independent variables and using the matrix derivatives

$$\frac{\partial Tr ( AXB )}{\partial X} = BA and \frac{\partial Tr ( {AX}^{H} B )}{\partial X} = 0 ,$$

(13) and (14) yield the following relations between Φ and Ψ:

(γHH^{H}+αI)Φ^{H}G^{H}Ψ^{H}ΨGΦ+μΦ^{H}Φ=\sqrt{γ}HΨ·GΦ (18)

ΨGΦ(γHH^{H}+αI)Φ^{H}G^{H}Ψ^{H}+βΨΨ^{H}=\sqrt{γ}Ψ·GΦ·H (19)

where in addition (13) is right-multiplied by Φ and (14) is left-multiplied by Ψ. In order to simplify the above system of equations, the singular value decompositions for both channel matrices are as follows:

H=TΣ·U^{H},TεM_{Mr},UεM_{Ms} (20)

G=VΛ·W^{H},VεM_{Md},WεM_{Mr} (21)

where the diagonal matrix [Σ]_{k,k}=σₖ, k=1, . . . , Ms, contains the ordered singular values of the channel matrix H, and the diagonal matrix [Λ]_{n,n}=λ_{π(n)}, n=1, . . . , N, where N=min(Mr,Md), contains the unordered eigenvalues of the channel matrix G. The symbol n has been used to denote a permutation of the ordered singular values λ₁≦λ₂≦ . . . λ_{N}. The relative ordering of the singular values of Σ and Λ will have an impact on the total MSE. Various embodiments of the present invention are directed to searching for the optimal permutation π* that minimizes the MSE among the Mr! permutations.

It is lengthy but straightforward to show that assuming the following structure for Φ and Ψ:

Φ=WD_{Φ}T^{H},D_{Φ}εM_{Mr} (22)

Ψ=UD_{Ψ}V^{H},D_{Ψ}εM_{Ms,Md} (23)

where D_{Φ}=diag {d_{Φ,1}, d_{Φ2}, . . . , d_{Φ,Mr}} is diagonal and D_{Ψ}=diag {d_{Ψ,1}, d_{Ψ,2}, . . . , d_{Ψ,Ms}} has zero entries elsewhere, equations (13) and (14) reduce to:

(γΣΣ^{H}+αI)D_{Φ}^{H}Λ^{H}D_{Ψ}^{H}D_{Ψ}ΛD_{Φ}+μD_{Φ}^{H}D_{Φ}=\sqrt{γ}ΣD_{Ψ}ΛD_{Φ} (24)

D_{Ψ}ΛD_{Φ}(γΣΣ^{H}+αI)D_{Φ}^{H}Λ^{H}D_{Ψ}^{H}+βD_{Ψ}^{H}D_{Ψ}=\sqrt{γ}D_{Ψ}ΛD_{Φ}Σ (25)

Note that the first matrix equation involves Mr equations of singular values, while the second involves Ms equations. If Ms=Mr=Md, the system can be dealt with easily. However, when this is not the case, some singular values will not play a role in the result (for Mr≦Md), or they will be deterministically zero (for Mr≧Md). In order to find the solution in a general form, the following relations are defined:

σ_{K}=[Σ]_{k,k}, k=1, . . . , K (26)

λ_{K}=[Λ]_{k,k}, k=1, . . . , K (27)

d_{ΦK}=[D_{Φ}]_{k,k}, k=1, . . . , K (28)

d_{ΨK}=[D_{Ψ}]_{k,k}, k=1, . . . , K (29)

where, for instance, σ_{K} denotes a column vector of K diagonal elements of Σ. If the matrix Σ has more diagonal entries than K, only the first K are taken; conversely, if Σ has less diagonal entries than K, the remaining entries of σ_{K} are filled with zeros. Using this notation, (24) and (25) are rewritten as:

(γσ_{Mr}²+αI)\textcircled{×}d_{ΦMr}²\textcircled{×}λ_{Mr}²\textcircled{×}d_{ΨMr}²+μd_{ΦMr}²=\sqrt{γ}σ_{Mr}\textcircled{×}d_{ΨMr}\textcircled{×}λ_{Mr}\textcircled{×}d_{ΦMr} (30)

(γσ_{Ms}²+αI)\textcircled{×}d_{ΦMs}²\textcircled{×}λ_{Ms}²\textcircled{×}d_{ΨMs}²+βd_{ΦMs}²=\sqrt{γ}σ_{Ms}\textcircled{×}d_{ΨMs}\textcircled{×}λ_{Ms}\textcircled{×}d_{ΦMs} (31)

where I denotes the all-ones vector of appropriate dimension, and \textcircled{×} denotes the Hadamard (i.e. element-wise) product. It eventually yields the following expressions for d_{Φ} and d_{Ψ}:

$$\begin{matrix}{d}_{Φ Ms}^{2} = {( \frac{γ}{β} {σ}_{Ms}^{2} ⊗ {λ}_{Ms}^{2} + \frac{α}{β} {λ}_{Ms}^{2} )}^{- 1} ⊗ ( \sqrt{\frac{γ}{μ β}} {σ}_{Ms} ⊗ {λ}_{Ms} - I ) \\ {d}_{Φ Mr}^{2} = {[ {( {d}_{Φ Ms}^{2} )}^{T} 0 … 0 ]}^{T} & ( 32 ) \\ {d}_{Ψ Ms}^{2} = \frac{μ}{β} {d}_{Φ Ms}^{2} & ( 33 )\end{matrix}$$

where (.)₊ indicates that the negative elements are replaced by zero. The number of independent streams that can be supported through the MIMO channel is given by the rank of the concatenated channel GH. Recalling that the power constraint is given by Tr(ΦΦ^{H})=Mr and assuming that M≦rank (GH) subchannels are used for transmission, the Lagrange multiplier μ is solution to the following equation derived from (32):

$$\sqrt{μ} = \frac{{\sum }_{k = 1}^{M} {( \frac{γ}{β} {δ}_{k}^{2} + \frac{α}{β} {λ}_{k}^{2} )}^{- 1} \sqrt{\frac{γ}{β}} {δ}_{k}}{Mr + {\sum }_{k = 1}^{M} {( \frac{γ}{β} {δ}_{k}^{2} + \frac{α}{β} {λ}_{k}^{2} )}^{- 1}} \qquad ( 34 )$$

where δₖ=σ_{Mr}(k)λ_{Mr}(π(k)), δ₁≧δ₂ . . . ≧δ_{N}. The optimal μ≧0 should ensure that the matrices D_{Φ} and D_{Ψ} have positive singular values (or equivalently, that the elements of d_{Φ} and d_{Ψ} have positive elements). One may observe that an element of D_{Φ}, say d_{Φk}, can only be negative if

$$\sqrt{μ} \geq \sqrt{\frac{γ}{β}} {δ}_{k} .$$

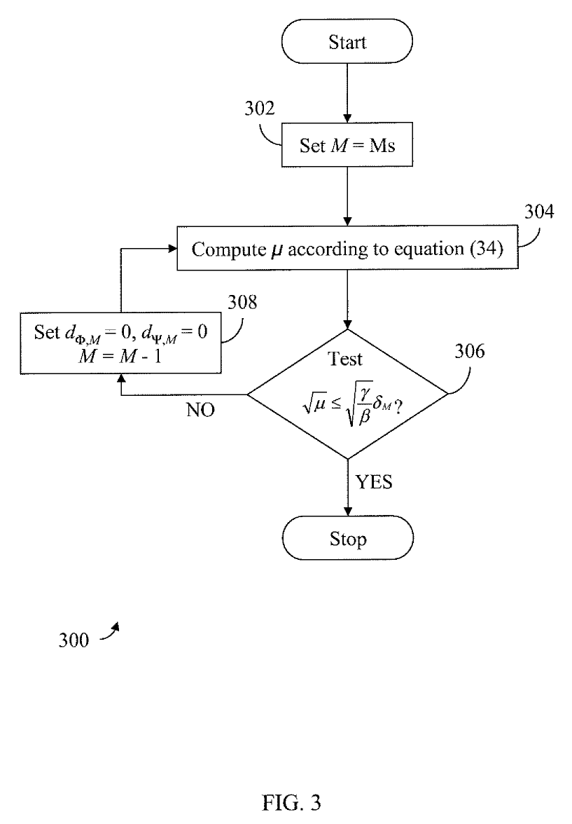

This observation forms the basis of an iterative method of computing the Lagrange multiplier μ described with reference to FIG. 3. In each iteration, the disclosed method sets the power allocated to weakest mode to zero, until a Lagrange multiplier μ for which all the remaining spatial modes are nonnegative is found. The resulting μ is then used to compute the singular values corresponding to the active sub-channels according to equations (32) and (33).

As discussed previously, the MSE is given by the trace of the error covariance matrix Cₑ. Employing the structure for Φ and Ψ assumed in (22) and (23) respectively, it can be shown that the MSE depends on D_{Φ} and D_{Ψ} according to the following relation:

$$\begin{matrix}MSE ( μ , {D}_{Φ} , {D}_{Ψ} ) = Tr ( \begin{matrix}( \sqrt{\frac{γ μ}{β}} {D}_{Ψ} Λ {D}_{Φ} \sum - I ) \\ {( \sqrt{\frac{γ μ}{β}} {D}_{Ψ} Λ {D}_{Φ} \sum - I )}^{H}\end{matrix} ) \\ \frac{α μ}{β} Tr ( {D}_{Φ} Λ {D}_{Ψ} {D}_{Ψ}^{H} {Λ}^{H} {D}_{Φ}^{H} ) + \\ μ Tr ( {D}_{Ψ} {D}_{Ψ}^{H} )\end{matrix} + \qquad ( 35 )$$

The MSE depends implicitly on the ordering of the singular values in Λ, represented by the permutation π of the ordered eigenvalues. In order to find the optimal solution, the above procedure should be applied for all Mr! possible π's, and the permutation π* that minimizes the MSE must be selected.

In an embodiment, the above procedure may be applied to only some of the Mr! possible permutations, in order to reduce the computational complexity of the approach. In this case, a chosen permutation π^{#}, the permutation yielding least MSE out of all the permutations to which the above procedure is applied, may be chosen for generating the relay and destination-unit transformations. This embodiment trades performance for computational simplicity.

In another embodiment, chosen permutation π^{#} corresponds to a pre-determined ordering of second singular values could also be used for generating the relay and destination-unit transforms. For example, a decreasing order, an increasing order, or a pre-determined order that has been observed to yield low MSE may be used. This approach avoids performing the tuning over all possible permutations. Again, this computational simplicity comes at the price of non-optimal MSE.

Thus, in various embodiments, chosen permutation π^{#} selected for forming relay transformation Φ and destination transformation Ψ may not be the optimal permutation π*.

In yet another embodiment of the present invention, relay transformation Φ and destination transformation Ψ may be selected to implement a Maximum Likelihood receiver at destination node 106. In this embodiment, destination transformation Ψ can be represented as the following equation:

$$r = arg {min}_{x} {‖ {R}_{n}^{- \frac{1}{2}} ( y - \sqrt{γ} G . Φ . H . x ) ‖}_{F}^{2} \qquad ( 36 )$$

Further, for a Maximum Likelihood receiver at destination node 106, relay node 104 applies relay transformation Φ as computed using equation (22), where D_{Φ} is given by the relation:

$${D}_{Φ}^{2} = \frac{1}{μ α} {{Λ}^{- 2} ( {\sum }^{2} - μ I )}_{+} \qquad ( 37 )$$

where μ is a constant computed as per the following relation:

$$μ = \frac{{\sum }_{k} \frac{{σ}_{k}^{2}}{{λ}_{π ( k )}^{2}}}{α M + {\sum }_{k} \frac{1}{{λ}_{π ( k )}^{2}}} \qquad ( 38 )$$

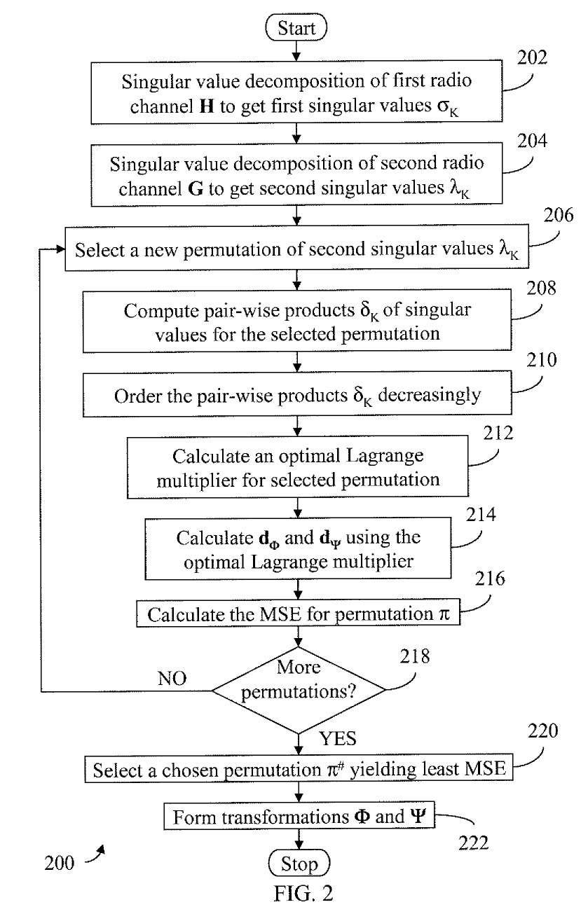

FIG. 2 is a flowchart depicting a method 200 of selecting the relay and destination transformations in accordance with an embodiment of the present invention. The method 200 begins at step 202, wherein singular value decomposition of first radio channel matrix H is performed, to obtain first singular values σ_{K}. Step 202 is performed in accordance with equations (20) and (26). Similarly at step 204, singular value decomposition of second radio channel matrix G is performed, to obtain second singular values λ_{K}. Step 204 is performed in accordance with equations (21) and (27).

Thereafter, the method tries at least one permutation of second singular values λ_{K}, and calculates the mean square error associated with each tried permutation. Finally, the permutation with the least mean square error is selected for forming at least one of relay transformation Φ and destination transformation Ψ. More specifically, at step 206, a new permutation π of first singular values σ_{K} and second singular values λ_{K} is selected. Then at step 208, pair-wise products δ_{K} of first singular values σ_{K} and second singular values λ_{K} are computed for permutation π. At step 210, the method sorts pair-wise products δ_{K} decreasingly (in descending order). The sorting is performed to ensure that, in each iteration of the method, the weakest mode among the remaining ones is considered. Then at step 212, the method calculates an Lagrange multiplier μ for permutation π. A method of calculating the Lagrange multiplier μ in accordance with an embodiment of the present invention is disclosed with reference to FIG. 3. Then, at step 214, the method calculates d_{Φ} and d_{Ψ} using the Lagrange multiplier μ. This calculation is in accordance with equations (32) and (33). Then at step 216, the mean square error for permutation π is calculated. The MSE is calculated between the destination output data r and source send data x using the Lagrange multiplier μ, d_{Φ}, and d_{Ψ}, in accordance with equation (35). At step 218, a check is performed to see if more permutations of second singular values λ_{K} should be considered. In an embodiment, all Mr! possible permutations of second singular values λ_{K} are considered. In another embodiment, only some of the possible permutations are considered. In this case, the permutations considered could be picked randomly. Alternatively, the permutations considered could be picked from a set of permutations that are known to yield low MSE. In yet another embodiment, only a single permutation is considered. The single permutation of second singular values λ_{K} could be, for example, an arrangement of second singular values λ_{K} in ascending order, or in descending order. The single permutation may also be one that is known to yield low MSE. If more permutations should be considered, the method loops back to step 206, to consider another new permutation π. In this manner, the MSE for at least one permutation it is calculated. Once the loop of steps 208, 210, 212, 214, and 216 has been completed for all permutations π that should be considered, the method proceeds to step 220.

At step 220, a chosen permutation π^{#} that yields the least MSE between the destination output data r and source send data x is selected from among all considered permutations π. Finally, at step 222, at least one of relay transformation Φ and destination transformation Ψ are formed using d_{Φ} and d_{Ψ} corresponding to chosen permutation π^{#}. Relay transformation Φ may be formed using equation (22). Similarly, destination transformation Ψ may be formed using equation (23).

FIG. 3 is a flowchart depicting an iterative method 300 of computing the Lagrange multiplier μ for a permutation of the singular values of the channel matrices H and G, in accordance with an embodiment of the present invention. At step 302, a mode count M is initialized to Ms. In other words, the maximum number of active modes for the joint tuning of Φ and Ψ is considered. Then at step 304, Lagrange multiplier μ is calculated according to equation (34). At step 306, an admissibility condition is checked. As discussed with reference to equation (34), an element of D_{Φ}, say d_{Φk}, can only be negative if

$$\sqrt{μ} \geq \sqrt{\frac{γ}{β}} {δ}_{k} .$$

### Therefore, the admissibility condition checks if

$$\sqrt{μ} \leq \sqrt{\frac{γ}{β}} {δ}_{M} .$$

If the condition is true, then the Lagrange multiplier μ has been obtained, and the method stops. On the other hand, if the admissibility condition is not true, then the method proceeds to step 308. At step 308, the last mode is dropped. In other words, the values of d_{Φ,M} and d_{Ψ,M} are set to zero, and mode count M is decremented by one. Thereafter, the method loops back to step 304, and a new value of Lagrange multiplier μ is computed using the decremented value of M. The method repeats in a loop of steps 304, 306, and 308, until the Lagrange multiplier μ is found.

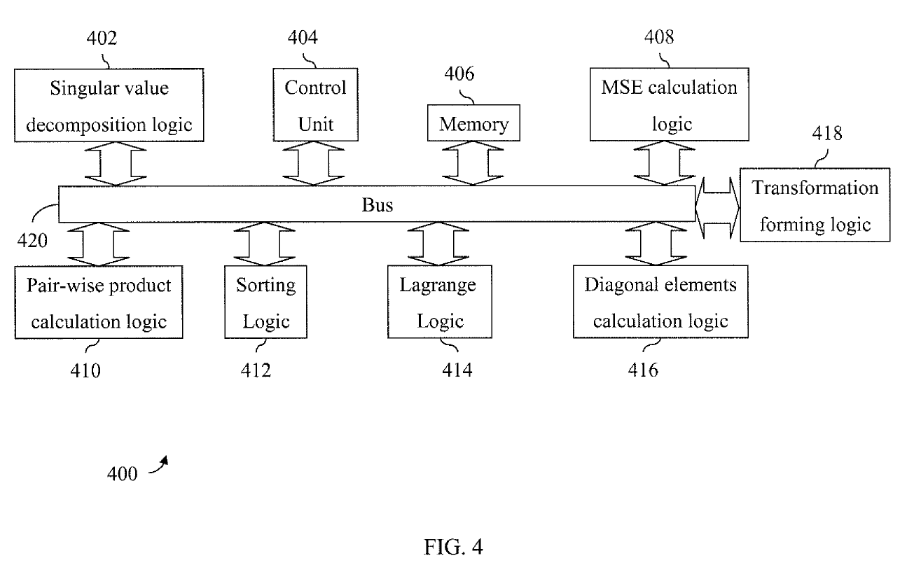

FIG. 4 is a block diagram schematically depicting a MIMO wireless network node 400, in accordance with an embodiment of the present invention. In various embodiments, MIMO wireless network node 400 shown in the figure is capable of executing the method described with reference to FIG. 2. MIMO wireless network node 400 comprises a singular value decomposition logic 402, a control logic 404, a memory 406, an MSE calculation logic 408, a pair-wise product calculation logic 410, a sorting logic 412, a Lagrange logic 414, a diagonal elements calculation logic 416, and a transformation forming logic 418 communicatively coupled with a bus 420. Singular value decomposition logic 402 performs singular value decomposition of channel matrices H and G. These decompositions yield first singular values GK of first radio channel matrix H in accordance with equations (20) and (26). Similarly, singular value decomposition logic 402 yields second singular values λ_{K} of second radio channel matrix G in accordance with equations (21) and (27). In various embodiments, singular values σ_{K} and λ_{K} are stored in memory 406.

Thereafter, the MIMO network node tries at least one permutation of second singular values λ_{K}, and calculates the mean square error associated with each tried permutation. The permutation with the least mean square error is selected for forming at least one of relay transformation Φ and destination transformation Ψ. More specifically, control logic 404 selects a new permutation X of second singular values λ_{K} Then pair-wise product calculation logic 410 computes pair-wise products δ_{K} of first singular values σ_{K} and second singular values λ_{K} for permutation π. Sorting logic 412 sorts pair-wise products δ_{K} decreasingly (in descending order). Then Lagrange logic 414 calculates an Lagrange multiplier u for permutation π. In various embodiments of the present invention, Lagrange logic 414 executes the iterative method disclosed with reference to FIG. 3. The sorting is performed to ensure that only the weakest modes are dropped in each iteration of this method. Then diagonal elements calculation logic 416 calculates d_{Φ} and d_{Ψ} using the Lagrange multiplier μ. This calculation is done in accordance with equations (32) and (33). MSE calculation logic 408 calculates the mean square error for permutation π. The MSE is calculated between source send data x and the expected value of destination output data r using the Lagrange multipliers, μ, d_{Φ}, and d_{Ψ}, in accordance with equation (35). Memory 406 stores d_{Φ}, d_{Ψ}, and the MSE for permutation π for subsequent access by transformation forming logic 418. Control logic 404 checks to see if more permutations of second singular values λ_{K} should be considered. In an embodiment, all Mr! possible permutations of second singular values λ_{K} are considered. In another embodiment, only some of the possible permutations are considered. In this case, the permutations considered could be picked randomly. Alternatively, the permutations considered could be picked from a set of permutations that are known to yield low MSE. In yet another embodiment, only a single permutation is considered. The single permutation of second singular values λ_{K} could be, for example, an arrangement of second singular values λ_{K} in ascending order, or in descending order. The single permutation may also be one that is known to yield low MSE. If more permutations should be considered, control logic 404 reinitiates the aforementioned logic to consider another new permutation π. This way, the MSE for at least one permutations π is calculated and stored in memory 406. Once the MSE corresponding to each considered permutation π is thus calculated and stored, control logic 404 selects a chosen permutation π^{#} that yields the least MSE between the destination output data r and source send data x. Finally control logic 404 invokes transformation forming logic 418 to form at least one of relay transformation Φ and destination transformation Ψ using d_{Φ} and d_{Ψ} corresponding to chosen permutation π^{#}. Relay transformation Φ may be formed using equation (22). Similarly, destination transformation Ψ may be formed using equation (23).

In various embodiments, logics 402, 408, 410, 412, 414 and 416, and control logic 404 may be implemented in hardware using Application Specific Integrated Circuits (ASICs), System-on-Chip (SoC) modules, Field Programmable Gate Arrays (FPGAs), or combinations thereof. In other embodiments, these may be implemented using software and/or firmware in conjunction with a general purpose processor.

The network node disclosed in conjunction with FIG. 4 may find application in a wireless interface card used in networks conforming to the Institute of Electrical and Electronics Engineers (IEEE) 802.11n Wireless Local Area Network (WLAN) protocol, the IEEE 802.16 Wireless Metropolitan Area Network (WMAN) protocol, the IEEE 802.16a WMAN protocol, and the IEEE 802.20 Mobile Broadband Wireless Access (MBWA) protocol.

Further, the network node disclosed in conjunction with FIG. 4 may find application in Third Generation Partnership Project 2 (3GPP2), and 4th Generation (4G) infrastructure and devices.

In general, this invention may find application in any wireless networking system which uses multiple-antennas and relays to communicate. For example, in cellular environments the relay transformation Φ may be applied at the relay which is a part of the infrastructure deployed by an operator to provide the service, and the destination transformation Ψ may be applied at mobile devices and base stations as applicable. In adhoc networks, the relay can be user equipment that cooperates with other users to communicate. In this case, the wireless interface of the user equipment may be configured to apply relay transformation Φ to data relayed by the user equipment and to apply destination transformation Ψ to data destined for the user equipment.

In various embodiments, the wireless network interface card is configured to receive data, or in other words, to perform the function of destination node 106 of the present invention. In these embodiments, transformation forming logic 418 may be configured to form only destination transformation Ψ. In other embodiments, the wireless network interface card is configured to relay data, or in other words, to perform the function of relay node 104 of the present invention. In these embodiments, transformation forming logic 418 may be configured to form only relay transformation Φ. In still other embodiments, the wireless network interface card is configured to both receive and relay data, for example in ad hoc networks. In these embodiments, transformation forming logic 418 may be configured to form both relay transformation Φ and destination transformation Ψ.

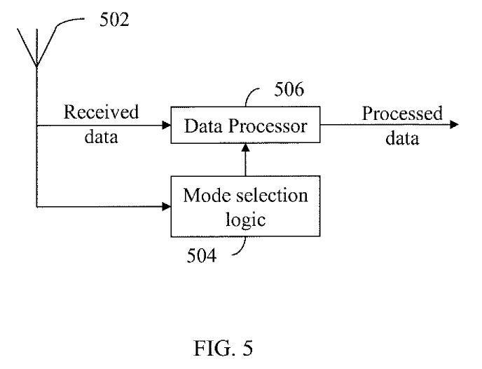

FIG. 5 shows a schematic diagram of a MIMO wireless network node 500 in accordance with another embodiment of the present invention. The figure shows a wireless antenna array 502, coupled to a mode selection logic 504, and a data processor 506. Wireless antenna array 502 is capable of receiving a MIMO wireless signal that has sub-signals associated with each antenna in the array. Wireless antenna array 502 receives a received data, which it feeds to both mode selection logic 504, and data processor 506.

Mode selection logic 504 is configured to select a desired mode of operation for the MIMO wireless network node. More specifically, mode selection logic 504 identifies whether MIMO wireless network node 500 is acting as a relay node for the received data, or is it the destination of the received data. Mode selection logic 504 correspondingly selects either the relay mode, or the destination mode as the desired mode of operation of MIMO wireless network node 500. Mode selection logic 504 communicates the selected desired mode of operation to data processor 506.

Data processor 506 is configured to apply either a relay transformation Φ or a destination transformation Ψ depending on the desired mode of operation to process the received data and obtain a processed data. If the desired mode of operation is the relay mode, the processed data may subsequently be retransmitted. On the other hand, if the desired mode of operation is the destination mode, the processed data may be presented for error detection and/or correction, and decoding, as applicable.

Data processor 506 and/or mode selection logic 504 may be implemented using a Digital Signal Processing (DSP) processor, a general purpose processor, an Application Specific Integrated Circuit (ASIC), or reconfigurable hardware including but not limited to an Field Programmable Gate Array (FPGA).

A technical effect of various embodiments of the present invention is provide high performance relaying for MIMO wireless networks using reduced the complexity relaying systems.

Various implementation approaches of the present invention have been discussed to illustrate, but not to limit, the present invention. It would be apparent to one skilled in the art that the selection of any of these approaches depends on the specific application of the present invention. Various other implementation approaches can be envisioned by one skilled in the art, without deviating from the spirit and scope of the present invention.

What is claimed is:

1. A MIMO relay apparatus comprising:
a data source node sending a source send data x over a first radio channel H;
a relay node receiving a relay receive data yᵣ from said first radio channel H, applying a relay transformation Φ to said relay receive data yᵣ to obtain a relay send data xᵣ, and sending relay send data xᵣ over a second radio channel G; and
a destination node receiving a destination receive data y from said second radio channel G, and applying a destination transformation Ψ to said destination receive data y to obtain a destination output data r representing an estimate of said source send data x;
wherein said relay transformation Φ and said destination transformation Ψ are jointly tuned with respect to each other.

2. The MIMO relay apparatus of claim 1, wherein the joint tuning of said relay transformation Φ and said destination transformation Ψ reduces a mean square error (MSE) between said source send data x and said destination output data r.

3. The MIMO relay apparatus of claim 1, wherein said relay transformation Φ and said destination transformation Ψ are jointly tuned by applying the Lagrange method and Karush-Kuhn-Tucker conditions to the problem of reducing the mean square error (MSE) between said source send data x and said destination output data r.

4. The MIMO relay apparatus of claim 1, wherein said relay transformation Φ and said destination transformation Ψ are chosen so that said destination output data r is the maximum-likelihood estimate of said source send data x.

5. The MIMO relay apparatus of claim 1, wherein at least one of said data source node, said relay node, and said destination node is a wireless communication device compliant with a communication standard selected from a group consisting of Institute of Electrical and Electronics Engineers (IEEE) 802.11n Wireless Local Area Network (WLAN), IEEE 802.16 Wireless Metropolitan Area Network (WMAN), IEEE 802.16a WMAN, IEEE 802.20 Mobile Broadband Wireless Access (MBWA), Third Generation Partnership Project 2 (3GPP2), and 4th Generation (4G).

6. A MIMO wireless network node for operating within a network having a source send data x supplied by a data source node in the network and a destination output data r generated by a destination node, said MIMO wireless network node comprising:
a data processor configured to apply at least one of a relay transformation Φ or a destination transformation Ψ to data supplied to said data processor;
when relay transformation Φ is applied, relay transformation Φ is jointly tuned with respect to destination transformation Ψ and, when destination transformation Ψ is applied, destination transformation Ψ is jointly tuned with respect to relay transformation Φ.

7. The MIMO wireless node of claim 6, wherein the joint tuning of said relay transformation Φ and said destination transformation Ψ reduces the mean square error (MSE) between said source send data x and said destination output data r.

8. The MIMO wireless network node of claim 6, wherein said relay transformation Φ and said destination transformation Ψ are jointly tuned by applying the Lagrange method and Karush-Kuhn-Tucker conditions to the problem of reducing the mean square error (MSE) between said source send data x and said destination output data r.

9. The MIMO wireless network node of claim 6, wherein said data processor applies said relay transformation Φ on a relay receive data yᵣ to get a relay send data xᵣ.

10. The MIMO wireless network node of claim 6, wherein said data processor applies said destination transformation Ψ on a destination receive data y to get destination output data r.

11. The MIMO wireless network node claim 6, wherein said relay transformation Φ and said destination transformation Ψ are chosen so that said destination output data r is the maximum-likelihood estimate of said source send data x.

12. The MIMO wireless network node of claim 6, wherein said data processor is coupled with a wireless communication device compliant with a communication standard selected from a group consisting of Institute of Electrical and Electronics Engineers (IEEE) 802.11n Wireless Local Area Network (WLAN), IEEE 802.16 Wireless Metropolitan Area Network (WMAN), IEEE 802.16a WMAN, IEEE 802.20 Mobile Broadband Wireless Access (MBWA), Third Generation Partnership Project 2 (3GPP2), and 4th Generation (4G).

13. An apparatus for relaying a source send data x from a data source node to a destination node, said apparatus comprising:
a Multiple-Input Multiple-Output (MIMO) antenna array to receive a relay receive data yᵣ and to send a relay send data xᵣ; and
a relay data processor for performing a relay transformation Φ on said relay receive data yᵣ to form said relay send data xᵣ, wherein said relay transformation Φ is jointly tuned with a destination transformation Ψ, wherein said destination node applies said destination transformation Ψ to compute a destination output data r.

14. The apparatus of claim 13, wherein said relay transformation Φ is jointly tuned with said destination transformation Ψ to reduce the mean square error (MSE) between said source send data x and said destination output data r.

15. The apparatus of claim 13, wherein said relay transformation Φ and said destination transformation Ψ are jointly tuned by applying the Lagrange method and Karush-Kuhn-Tucker conditions to the problem of reducing the mean square error (MSE) between said source send data x and said destination output data r.

16. The apparatus of claim 13, wherein said relay data processor comprises:
a singular value decomposition logic configured to perform singular value decomposition of matrices representing said first radio channel H and said second radio channel G, to obtain first singular values σ_{K} and second singular values λ_{K};
a pair-wise product calculation logic configured to compute pair-wise products δ_{K} of said first singular values σ_{K} and said second singular values λ_{K};
a sorting logic configured to sort said pair-wise products δ_{K} in descending order;
a Lagrange logic configured to calculate an Lagrange multiplier μ using said pair-wise products δ_{K} and said second singular values λ_{K};
a diagonal elements calculation logic configured to calculate a relay vector d_{Φ} and a destination vector d_{Ψ} using said Lagrange multiplier μ;
an MSE calculation logic configured to calculate the expected MSE between said source send data x and said destination output data r if said relay transformation Φ and said destination transformation Ψ are formed using said relay vector d_{Φ} and said destination vector d_{Ψ};
a control logic configured to identify a chosen permutation π^{#} of said second singular values λ_{K} that yields the least MSE between said destination output data r and said source send data x; and
transformation forming logic configured to form at least one of said relay transformation Φ and said destination transformation Ψ using said relay vector d_{Φ} and said destination vector d_{Ψ} corresponding to said chosen permutation π^{#}.

17. The apparatus of claim 13, wherein said relay transformation Φ and said destination transformation Φ are chosen so that said destination output data r is the maximum-likelihood estimate of said source send data x.

18. An apparatus for receiving a source send data x from a data source node through a relay node, said apparatus comprising:
a Multiple-Input Multiple-Output (MIMO) antenna array to receive a destination receive data y; and
a destination data processor for performing a destination transformation Ψ on said destination receive data y to form a destination output data r, wherein said destination transformation Ψ is jointly tuned with a relay transformation Φ, wherein said relay node applies said relay transformation Φ for relaying data.

19. The apparatus of claim 18, wherein said destination transformation Ψ is jointly tuned with said relay transformation Φ to reduce the mean square error (MSE) between said source send data x and said destination output data r.

20. The apparatus of claim 18, wherein said relay transformation Φ and said destination transformation Ψ are jointly tuned by applying Lagrange tuning and Karush-Kuhn-Tucker conditions to the problem of reducing the mean square error (MSE) between said source send data x and said destination output data r.

21. The apparatus of claim 18, wherein said destination data processor comprises:
a singular value decomposition logic configured to perform singular value decomposition of matrices representing said first radio channel H and said second radio channel G, to obtain first singular values σ_{K} and second singular values λ_{K};
a pair-wise product calculation logic configured to compute pair-wise products δ_{K} of said first singular values σ_{K} and said second singular values λ_{K};
a sorting logic configured to sort said pair-wise products δ_{K} in descending order;
a Lagrange logic configured to calculate an Lagrange multiplier μ using said pair-wise products δ_{K} and said second singular values λ_{K};
a diagonal elements calculation logic configured to calculate a relay vector d_{Φ} and a destination vector d_{Ψ} using said Lagrange multiplier μ,
an MSE calculation logic configured to calculate the expected MSE between said source send data x and said destination output data r if said relay transformation Φ and said destination transformation Ψ are formed using said relay vector d_{Φ} and said destination vector d_{Ψ};
a control logic configured to identify a chosen permutation π^{#} of said second singular values λ_{K} that yields the least MSE between said destination output data r and said source send data x; and
transformation forming logic configured to form at least one of said relay transformation Φ and said destination transformation Ψ using said relay vector d_{Φ} and said destination vector d_{Ψ} corresponding to said chosen permutation π^{#}.

22. The apparatus of claim 18, wherein said relay transformation Φ and said destination transformation Ψ are chosen so that said destination output data r is the maximum-likelihood estimate of said source send data x.

23. A method of operating MIMO wireless network node within a network having a source send data x supplied by a data source node in the network and a destination output data r generated by a destination node, said method comprising:
applying at least one of a relay transformation Φ or a destination transformation Ψ to data supplied to said MIMO wireless network node;
when relay transformation Φ is applied, relay transformation Φ is jointly tuned with respect to destination transformation Ψ and, when destination transformation Ψ is applied, destination transformation Ψ is jointly tuned with respect to relay transformation Φ.

24. The method of claim 23, wherein said relay transformation Φ and said destination transformation Ψ are jointly tuned by applying the Lagrange method and Karush-Kuhn-Tucker conditions to the problem of reducing the mean square error (MSE) between said source send data x and said destination output data r.

25. The method of claim 23 further comprising:
performing singular value decomposition of said first radio channel H to obtain a set of first singular values σ_{K};
performing singular value decomposition of said second radio channel G to obtain a set of second singular values λ_{K};
for at least one permutation π of pairing of said first singular values σ_{K} and said second singular values λ_{K}, performing the following steps:
computing pair-wise products δ_{K} of said first singular values σ_{K} and said second singular values λ_{K} for said permutation π;
sorting said pair-wise products δ_{K} in descending order;
calculating an Lagrange multiplier μ for said permutation π;
calculating a relay vector d_{Φ} and a destination vector d_{Ψ} using said Lagrange multiplier μ; and
calculating the mean square error (MSE) between said destination output data r and said source send data x using said Lagrange multiplier μ, said relay vector d_{Φ}, and said destination vector d_{Ψ};
selecting a chosen permutation π^{#} that yields the least MSE between said destination output data r and said source send data x; and
forming at least one of said relay transformation Φ and said destination transformation Ψ using said relay vector d_{Φ} and said destination vector d_{Ψ} corresponding to said chosen permutation π^{#}.

26. The method of claim 25, wherein calculating said Lagrange multiplier μ comprises:
initializing a mode count to the number of sub-signals Ms in said source send data x;
computing a value of Lagrange multiplier μ;
testing said value of Lagrange multiplier μ for an admissibility condition;
decrementing said mode count and returning to said step of computing, if said value of Lagrange multiplier μ fails the admissibility condition test; and
identifying said value of Lagrange multiplier μ as said Lagrange multiplier μ, if said value of Lagrange multiplier μ passes the admissibility condition test.

27. The method of claim 23, wherein said relay transformation Φ and said destination transformation Ψ are chosen so that said destination output data r is the maximum-likelihood estimate of said source send data x.
